(19) United States
(12) Patent Application Publication
(10) Pub. No.: US 2023/0010620 A1
(43) Pub. Date: Jan. 12, 2023

(54) BOWTIE PROCESSING FOR RADIANCE IMAGE RENDERING

(71) Applicant: 3D Patents, LLC, Mission Hills, KS (US)

(72) Inventors: Thomas Lawrence Burnett, III, Austin, TX (US); Justin Alain Jensen, Leander, TX (US); Justin E.S. Halter, Pflugerville, TX (US)

(21) Appl. No.: 17/858,967

(22) Filed: Jul. 6, 2022

Related U.S. Application Data
(60) Provisional application No. 63/218,757, filed on Jul. 6, 2021.

(51) Int. Cl. G06T 15/08; G06T 15/06; G06T 15/00

(52) U.S. Cl. CPC G06T 15/08; G06T 15/06; G06T 15/005

(57) ABSTRACT

Systems and methods and computer program products for processing three-dimensional (3D) graphics are provided. A method includes receiving 3D geometry data for a shape to be rendered to a display that comprises an array of hogels, the shape defined in a model space. The method can further include reducing downstream processing of the 3D geometry data to render the shape to the display, comprising identifying a subset of hogels in a hogel plane that have hogel bowtie frustums that intersect the shape.

### RELATED APPLICATIONS

This application claims the benefit of priority under 35 U.S.C. 119(e), to U.S. Provisional Application No. 63/218,757, entitled “BowTie Clipping for Extreme Multi-view Radiance Image Rendering,” filed Jul. 6, 2021, which is hereby fully incorporated by reference herein for all purposes.

### TECHNICAL FIELD

This disclosure pertains to computer graphics. More particularly, embodiments relate to bowtie rasterization techniques for image rasterization. Even more particularly, embodiments relate to bowtie rasterization techniques for rendering three-dimensional (“3D”) light-field display (LfD) radiance images.

### BACKGROUND

The ability to resolve depth within a scene, whether natural or artificial, improves our spatial understanding of the environment and as a result reduces the cognitive load accompanying the analysis and collaboration on complex 3D tasks. A light field display (LfD) provides a 3D image with the color and depth cues expected by the human visual system to create a synthetically generated 3D visual experience that is more natural to the observer than provided by other types of 3D displays.

In a synthetically generated light field radiance image, a pixel can represent a light ray originating on either side of the LfD image plane, which effectively doubles the projection depth of an LfD since a 3D aerial image can be rendered on either side of the image plane. While many hogel views (micro-images) are rendered to create one radiance image per update of the light-field display, each viewer perceives, for example, a perspective correct 3D aerial image with depth cues expected by the human visual system.

Light-field radiance image rendering is an example of extreme multi-view rendering where a scene is rendered from many (e.g., thousands to millions of) viewpoints per update/refresh of the display. While a graphics processing unit (GPU) can be used to compute a light-field radiance image, conventional GPUs and their accompanying APIs (e.g., OpenGL, DirectX, Vulkan) are generally designed to render a scene from one point of view to a single large viewport/framebuffer. That is, the typical GPU raster pipeline expects to render a scene from a single viewpoint per dispatch of the scene geometry. Therefore, the burden of radiance image rendering falls to the host application, which must understand the exact nature of the display's projection system and render all the appropriate views sequentially. For every view rendered, the host application sets the camera view matrix, the viewport to render to, and redispatches the scene's render commands. The update rate of the display and thus the power required to render animated content is a function of scene complexity (e.g., number of triangles, textures, lights, state changes, etc.) and the number of scene dispatches (renders/views). Complex scenes require exceedingly long computation times during which the light-field display is unresponsive to users.

A number of techniques have been developed to rasterize light field radiance images, including double frustum rendering as described in Michael W. Halle, Adam B. Kropp. 1997, “Fast Computer Graphics Rendering for Full Parallax Spatial Displays,” Proc. Soc. Photo-Opt. Instrum. Eng. (SPIE), 3011:105-112 (Feb. 10-11, 1997) and oblique slice and dice full-parallax, light-field radiance image as described in Thomas Burnett, “Light-Field Displays and Extreme Multiview Rendering,” Information Display, Vol. 6, 2017 (pages 6-13, 32).

The major difference between these rasterization approaches is the order in which they decompose a 4D light-field (two dimensions of position, two dimensions of direction) into 2D rendering passes. The double frustum technique renders hogel micro-images using two independent frustums for each hogel, a back perspective frustum and a front perspective frustum. The oblique slice and dice technique renders directions using sheared orthographic projections; after which, every oblique pixel must be transformed/swizzled and/or sampled into hogel micro-images.

The double frustum technique has at least one notable drawback, at least when implemented in OpenGL with the traditional perspective camera matrix. In OpenGL, the perspective camera matrix cannot be defined with the near plane on or behind the virtual camera origin. Rather, the near plane—that is, the clipping plane nearest to the virtual camera—is defined at a positive offset, with the expectation that the viewport is mapped to the near plane. If the front and back frustum definitions share the same origin, then there exists a small region between the two frusta near planes that is not seen by either camera: the Epsilon region. Portions of triangles that pass through the Epsilon region are not rendered, resulting in un-rasterized portions of the image which leads to visible artifacts when the image is projected by the display. One solution is to back offset the virtual cameras so that the near planes are coplanar and keep the near plane offset small. While this reduces, it does not eliminate all hogel corruption.

The oblique slice and dice technique uses an orthographic camera projection with a shear applied to render all the pixels for a particular view direction during each pass of the geometry. The shear matrix is adjusted for each projection ‘direction’ the light field display can produce. The oblique slice and dice technique algorithm does not generate the radiance image directly and requires a pixel transform where every pixel is moved from oblique render space into the radiance image.

Moreover, both the double frustum technique and the oblique slice and dice technique are view-major rendering techniques. That is, according to these techniques all of the triangles for a view of a scene (i.e., all of the triangles for a particular hogel) are rendered before proceeding to the next view/hogel.

For an LfD display, view-major rendering techniques set the viewport for a particular view and then render all the triangles from all the scene objects onto that viewport. If there are many objects in a scene (as there often are) with unique vertex lists, textures, materials, and so forth, then there is the potential that the same object data is being constantly swapped in and out of the processor cache, possibly on a per-view or per-hogel basis.

### SUMMARY

Embodiments of the present disclosure can include systems, methods and computer program products for processing three-dimensional (3D) graphics data. More particularly, embodiments include using bowtie (or pinhole) frustums. One embodiment comprises receiving 3D geometry data for a 3D scene to be rendered to a display, which may comprise an array of hogels. The 3D geometry data can define a set of shapes (objects, constituent polygons of objects or other shapes). A shape can be defined in a model space. Further, embodiments can include reducing downstream processing of the 3D geometry data to render the shape to the display's radiance image. Identifying a subset of hogels in a hogel plane that have hogel bowtie frustums that intersect the shape. In one embodiment, identifying the subset of hogels comprises reverse casting a bowtie frustum from the shape onto a hogel plane. In another embodiment, identifying a subset of hogels in a hogel plane that have hogel bowtie frustums that intersect the shape comprises performing a binary search or other search for hogels.

One aspect of the present disclosure includes using, as an invertible pinhole projection as a hogel camera frustum or a reverse cast frustum.

According to yet another aspect of the present disclosure, a hogel plane definition (HPD) is provided that is a 2D array of bowtie frustums. As the HPD in such embodiments is a 2D array of bowtie frustums, knowledge gained by triangle vertex clipping/culling operations can reduce the number of intersection tests globally performed on the radiance image definition and accelerate rendering. Valid triangle-bowtie frustum intersection tests can be determined via a binary search or reverse casting the bowtie frustum definition from a model's bounding volume minimum and maximum extents or a triangle's vertices onto the radiance image hogel plane defined in or transformed into model space. The resulting intersections define a subset of hogels whose frustums may intersect that triangle.

Another aspect of the present disclosure includes object culling. In one embodiment, the shape may be an object defined in the model space, the object having a bounding volume with extents. Bowtie frustums can be reverse cast from the bounding extents onto the hogel plane to identify the subset of hogels that have hogel frustums that intersect the object. The object culling may be performed, in some embodiments in a hogel plane definition space.

Another aspect of the present disclosure includes triangle culling. In one embodiment, the shape comprises a triangle defined in the model space. Triangle culling can include reverse casting bowtie frustums from the vertices of the triangle onto the hogel plane to identify a subset of hogels that have hogel frustums that intersect the triangle. The triangle culling is performed, in some embodiments, in a hogel plane definition space.

Yet another aspect of the present disclosure includes performing triangle clipping in model space. A hogel plane is transformed to model space. A clipping operation can include testing the hogel camera frustums of a subset of hogels for intersection with the triangle.

Another aspect of the present disclosure includes performing a triangle clipping operation that returns a direction in which the triangle lies from a hogel's frustum. The direction can be used to search to search (for example perform a binary search) of a 2D array of hogel frustums for an intersection with the triangle. According to one embodiment, during the 2D array search of hogel frustums, if the plane equations are normalized, then the plane equation dot product returns the distance to the point, which can be used to index the image plane frustum definition and shorten the search.

According to one embodiment, when triangle vertices are clipped against a hogel frustum, the triangle clipper labels the culled vertices with the distance and direction of those vertices from the hogel in model space. The resulting vector then can be used to index the hogel plane definition (HPD) to identify an intersecting hogel frustum (if any).

According to another aspect of the present disclosure, when all the bow tie frustums lie on a plane—that is, all the bowtie frustums have centers on the same plane and have the same normals, only one set of bowtie frustum planes needs to be defined and transformed into model space. Specific bowtie frustum planes can then be derived by a series of scaled additions, saving memory and multiplies. Lastly, during the triangle clipping/culling operation, the clip/cull direction can be used to reduce the number of hogel frustum/triangle intersections tests within the global 2D radiance image definition.

In some embodiments, hogels lie on a plane have the same orientation. For example, all the bowtie frustums have centers on the same plane and have the same normals. One bowtie frustum plane definition can be transformed through scaled addition for each of the hogels in the plane. That is, one set of hogel bowtie frustum planes can be defined and transformed to model space. The frustum planes for other hogels can be derived by a series of scaled additions, saving memory. This enables subsequent bowtie frustums to be transformed through addition alone. For example, one embodiment includes transforming a hogel bowtie frustum for one hogel to the model space, and the determining hogel bowtie frustums for the others hogels in the model space through a scaled addition.

Yet another aspect of the present disclosure includes performing rendering operations in a triangle-major manner.

Moreover, during the triangle clipping/culling operation, the clip/cull direction can be used to reduce the number of hogel frustum/triangle intersections tested (e.g., within the global 2D radiance image definition).

### BRIEF DESCRIPTION OF THE DRAWINGS

The subject matter of the present application may be better understood, and the numerous objects, features, and advantages made apparent to those skilled in the art, by referencing the accompanying drawings.

FIG. 1 is a diagrammatic representation of one embodiment of a hogel plane and a 3D model in a common coordinate space.

FIG. 2 is a diagrammatic representation of one embodiment of a light-field radiance image.

FIG. 3 illustrates one embodiment of a 3D model projected on a full parallax LfD.

FIG. 4A is a diagrammatic representation of one embodiment of a projection matrix for a bowtie frustum and 4B illustrates an example of the projection matrix in code.

FIG. 5 is a diagrammatic representation of one embodiment of deriving clipping planes from a projection matrix using the GLM Mathematics library.

FIG. 6 is a diagrammatic representation of a standard, right-handed, Y-UP, world space coordinate system.

FIG. 7 is a diagrammatic representation of the bowtie projection matrix.

FIG. 8 is a diagrammatic representation of one embodiment of a hogel plane definition.

FIG. 9 provides one example embodiment of code for determining the clipping planes for other hogels in a hogel plane through addition.

FIG. 10A is a diagrammatic representation of one embodiment of reverse frustum cast from triangle vertices. FIG. 10B provides a closer view of FIG. 10A from a second perspective.

FIG. 11 is a diagrammatic representation of one embodiment of testing a triangle for hogel frustum intersection.

FIG. 12 is a diagrammatic representation of one embodiment of performing a binary search for hogel frustum intersection.

FIG. 13 is a diagrammatic representation of one embodiment of a radiance image rendering pipeline for rendering micro-images to a radiance image target.

FIG. 14 is a diagrammatic representation of one embodiment of an MvPU.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As will be appreciated, the term “hogel” refers to a holographic element. In this description, “hogel” is generally used to refer to a micro-lens and may refer to an actual display hogel (that is, the physical hogel of the display) or a virtual hogel (that is, the virtual representation of a hogel used when processing 3D-data). In some cases, the term hogel may also refer to the accompanying micro-image, as will be clear by context.

Embodiments described herein relate to light-field rasterization, which is the process by which a 3D-scene is rendered into a light-field radiance image. As will be appreciated, a light field can be described as a set of rays that pass through a volume of space and is typically represented in computer vision as a plenoptic function. A light-field radiance image is a raster description of a light-field. In some embodiments, each pixel in the light-field radiance image represents a unique ray within the volume of space. Light field radiance image rasterization is the process by which a 3D-scene is rendered into a light-field radiance image. The light-field radiance image can be projected through an array of hogel micro-lenses to reconstruct a 3D image, such as a perspective-correct 3D aerial image visible for all viewers within the display's projection frustum.

A light-field display (“LfD”) typically comprises an array of hogel micro-lenses, photonics, such as an array of special light modulators (SLMs) or other photonics, and a computation system to compute light field radiance images. The photonics and optics form an array of micro-projectors. To project a light-field radiance image, each micro-projector projects a viewpoint specific image (a “micro-image” or “hogel image”) through a corresponding hogel micro-lens that angularly distributes the light. According to one embodiment, each micro-image represents all of the perspective rays that pass through a corresponding point spot on the light-field image plane of the LfD. For example, each micro image can represent the position, direction, intensity, and color of light rays that pass through the point spot as described, for example, by a plenoptic function.

As mentioned, light-field radiance image rasterization is an example of multi-view rendering. A 3D scene may be rendered, for example, from many points of view per update of the light-field display. U.S. Pat. No. 10,573,056, entitled “Multi-View Processing Unit Systems and Methods,” issued Feb. 25, 2020, to Burnett et al., which is hereby fully incorporated by reference herein, describes rendering techniques that apply a double-sided frustum (referred to as a “bowtie” frustum). Unlike the double frustum techniques that require two virtual cameras per hogel to project independent front and back frustums, bowtie frustum techniques can project a double-sided frustum a front portion (e.g., a portion to the front of the virtual camera) and the rear portion (e.g., a portion to the rear of the virtual camera) as part of the same frustum. Some embodiments of bowtie frustum rendering techniques can thus render multiple sides of a hogel image in a single pass of the geometry using a single bowtie frustum and without having to employ conjugate cameras for a single position. U.S. Pat. No. 10,573,056 further describes embodiments of various multi-view display systems and multi-view processing units (MvPUs), that can, at a high level, implement parallel render pipelines to render the multiple views of a scene in parallel.

The present disclosure provides improved rendering techniques using a bowtie frustum, pipelines that implement bowtie frustum rendering techniques, and radiance image renderers using bowtie frustum techniques. Such techniques may be implemented in a variety of graphics pipelines and multi-view devices, including but not limited to, multi-view display systems and MvPUs that implement parallel rendering pipelines to render multiple views of a scene in parallel.

Radiance image renderers that apply bowtie frustum techniques (referred to herein as “bowtie renderers”) can take advantage of performance optimizations inherent in extreme multi-view, full-parallax, synthetic radiance image rendering. Some embodiments of bowtie renderers according to the present disclosure use a single definition bowtie/pinhole projection matrix and invert the triangle/view rendering priority to provide triangle-major rendering.

In addition, or in the alternative, embodiments of bowtie renderers of the present disclosure can implement more efficient culling and clipping. In general, 3D graphics pipelines perform object culling in world space and triangle clipping in a unity clipping space. According to one aspect of the present disclosure, a bowtie renderer can perform one or more of the following: object culling in a hogel plane definition (HPD) space, triangle culling in the HPD space, or triangle clipping in model space.

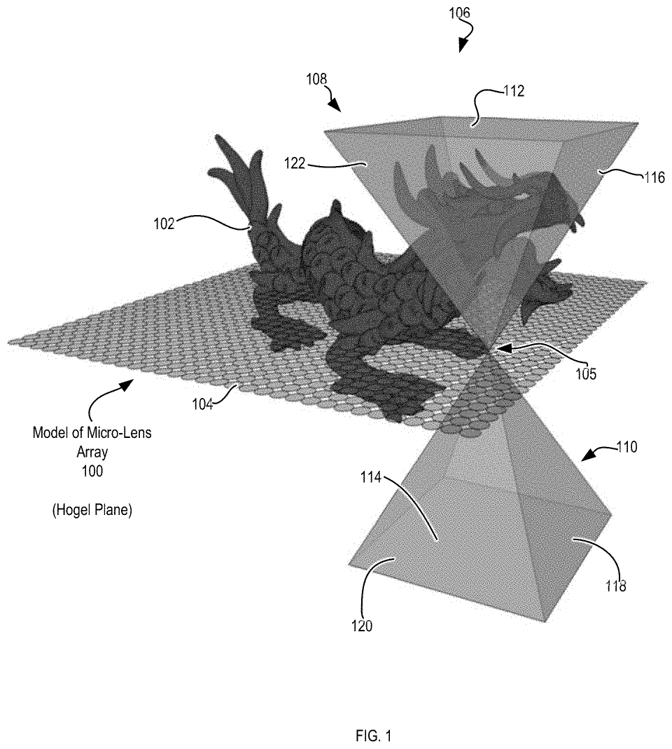

FIG. 1 is a diagrammatic representation of one embodiment of a hogel plane 100 and a 3D model 102—in this case a dragon—in a common coordinate space. Hogel plane 100 is a micro-lens array model that models the array of actual hogels of the display and, in the illustrated embodiment, also represents the image plane. In this example, hogel plane 100 models a display with a 32×32 micro-lens array capable of simultaneously projecting 1024 micro-images and thus includes 32×32 virtual hogels (virtual hogel 104 and virtual hogel 105 are labeled). Each virtual hogel (virtual micro-lens) in virtual hogel plane 100 represents the position and orientation of a corresponding actual hogel (e.g., physical micro-lens) of the display device. Virtual hogel 104 for example represents the position and orientation of an hogel (micro-lens) of the display system to which a pipeline is rendering and is defined by a viewpoint for that hogel. Similarly, virtual hogel 105 represents the position and orientation of another actual hogel of the display system. The hogel plane 100 can be defined in one or more hogel plane definitions, examples of which are discussed below, transformed into a common coordinate space with model 102.

At a high-level, the geometry data of 3D model 102 is processed to transform the geometry data of 3D model 102 into a light-field radiance image. For each hogel, a hogel frustum is projected in front of and to the back of the image plane at that hogel. The geometry that falls within that frustum is rasterized to generate a micro-image for the hogel that considers the hogel's viewpoint. With bowtie rendering, a virtual camera can project a single frustum that extends to the front of and behind the image plane to process geometry on either side of the image plane in a single pass of the geometry.

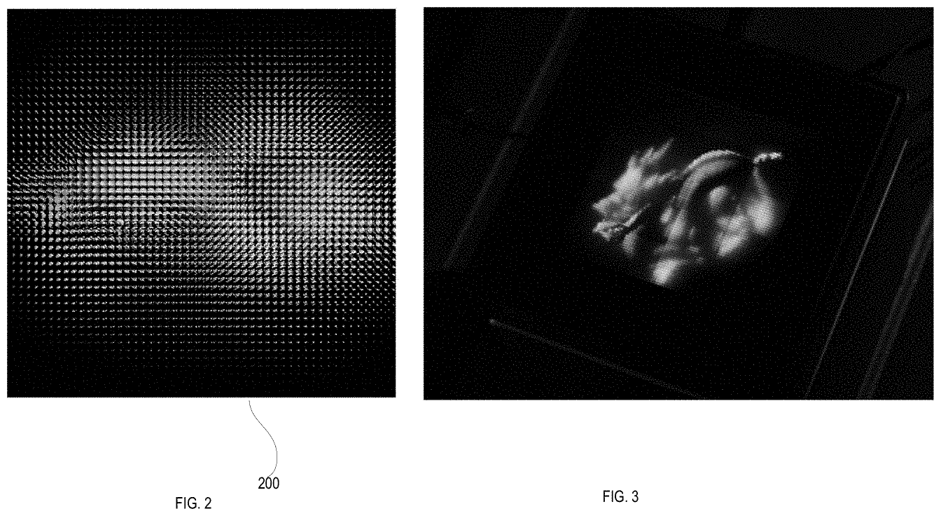

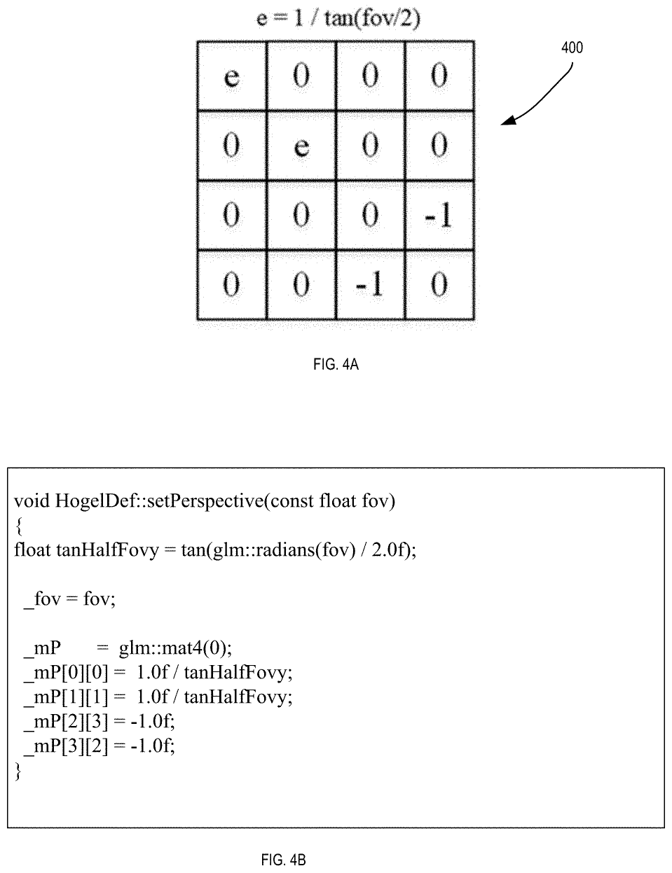

A micro-image can be generated for each hogel. Turning briefly to FIG. 2, a light-field radiance image 200 can thus be generated. Light-field radiance image 200 comprises an array of view-point specific micro-images (1024 micro-images in this example), where each view-point specific micro-image corresponds to a different hogel. When these micro-images are simultaneously projected through the micro-lens array of the LfD display, the superposition of these viewpoint specific images creates a 3D effect when viewed by the human visual system and human viewers perceive a perspective-correct 3D aerial image visible for all viewers within the display's projection frustum. FIG. 3, for example, illustrates 3D model 102 projected on a full parallax LfD. Embodiments of bowtie rendering can thus render the 3D aerial image for all viewers within the LfDs projection volume.

Returning to FIG. 1, each virtual hogel in hogel plane 100 has a center point or other point that represents the optical center of an actual hogel. For example, in an even more specific embodiment, the origin of each virtual hogel in a viewpoint specific eye space for that virtual hogel corresponds to the optical center of the corresponding actual hogel. This point can be used as the position of a virtual hogel camera to project a bowtie frustum for that hogel.

FIG. 1 illustrates projecting a hogel frustum for virtual hogel 105. In this example, the virtual hogel camera is positioned at the center point of virtual hogel 105, which corresponds to the optical center of the actual hogel that the virtual hogel 105 represents. Perspective projection is used to project a hogel bowtie frustum 106. As described in U.S. Pat. No. 10,573,056, a bowtie frustum can be defined for a camera position in which the frustum bounded by six planes: planes at +−z (front plane 112 and back plane 114) and four side planes 116, 118, 120, 122, where the side plane edges that span between the z plane and −z plane all pass through the center point of the virtual hogel 105 (the side planes of a bowtie frustum are referred to herein as left plane, a right plane, a top plane, and a bottom plane). The origin of virtual hogel 105 (at least in the viewpoint-specific eye space for that virtual hogel) corresponds to the optical center of the corresponding actual hogel. The angle between opposite side planes (e.g., the angle between planes 116, 118 and the angle between planes 120, 122) corresponds to the field of view (FOV) of the corresponding actual hogel.

Bowtie frustum 106 includes a front portion 108 to a front side of the virtual camera position and a back portion 110 behind the virtual camera position. Since the virtual camera position in FIG. 1 lies on the image plane, front portion 108 is in front of the image plane and back portion 110 is behind the image plane. Unlike with double frustum rendering that uses multiple frustums per hogel, the front portion 108 and back portion 110 of bowtie frustum 106 are portions of the same hogel frustum and not separately defined frustums.

Bow-tie frustum 106 can be used to determine, for example, which geometry (e.g., which triangles) to rasterize for virtual hogel 105 when generating a micro-image to be projected by the corresponding actual hogel of the display system.

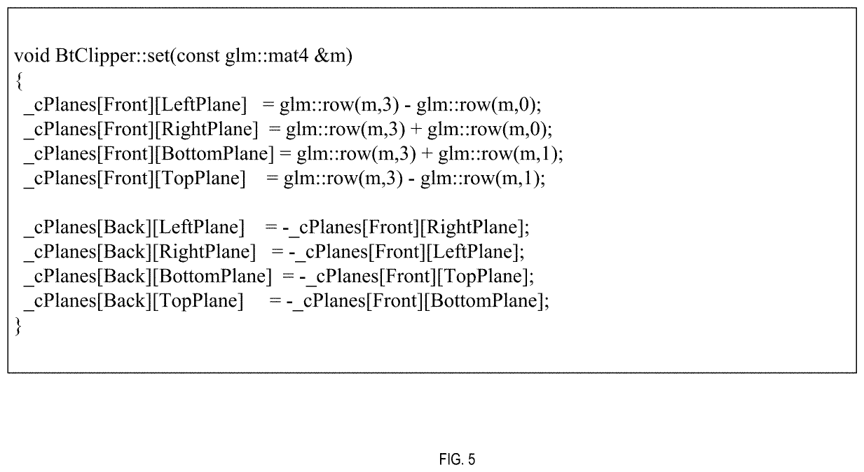

In the illustrated embodiment, the bowtie frustum is defined with a positive far plane in front, and a negative near plane behind. However, the bowtie frustum can also be defined without either the near plane 112 or the far plane 114. In other words, the hogel bowtie frustum can be defined as four side planes, where the side plane edges all pass through the virtual camera point. For example, frustum 106 passes through the center point of virtual hogel 105 and extends infinitely fore and aft. The side planes define an infinite fore and aft bowtie frustum. In such an embodiment, the bowtie frustum (e.g., bowtie frustum 106 without front plane 112 and rear plane 114) can be thought of as essentially an invertible pinhole projection, bisected by a hogel plane 100. FIG. 4A illustrates one embodiment of a projection matrix 400 for a bowtie frustum (‘fov’ in FIG. 4A is “field of view” of the hogel) and FIG. 4B illustrates one embodiment of implementing a bowtie frustum for a hogel using OpenGL Mathematics library.

As discussed below, bowtie frustums can be used in object culling, triangle culling, triangle clipping, and other operations. Since the bowtie frustum side planes (e.g., planes 116, 118, 120, 122) have different normals above and below the hogel plane/image plane, the plane equations used for triangle culling/clipping operations can be different for the front and back halves of the bowtie frustum 106. This can be accounted for in code using two sets of plane equations: a set for the front portion 108 and a set for the back portion 110 of the bowtie frustum.

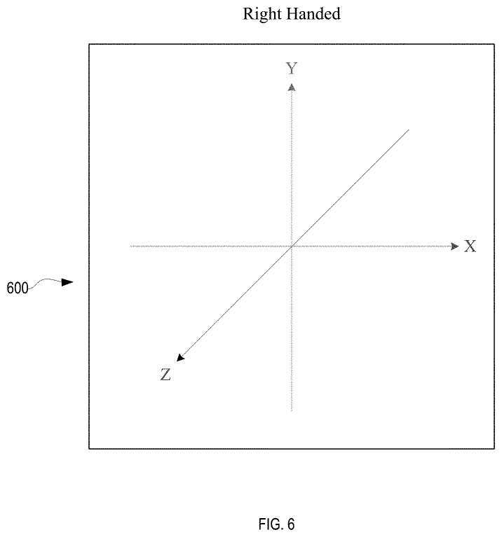

The hogel plane 100 is itself a plane having a plane equation that can be used to determine whether clipping should occur by use of the front, back or both sets of clipping planes. In some embodiments, this test is performed once per triangle (per object) per render cycle and the result cached for subsequent bowtie triangle/frustum clipping operations. FIG. 5 illustrates one embodiment of deriving clipping planes from a 4×4 projection matrix using the GLM library. The clipping planes can be used in a number of clipping operations including, but not limited to, shift clipping and smart clipping as discussed below. As will be appreciated, a triangle can intersect both front and back portions of a bowtie frustum. However, if the triangle is single-sided, it may only be visible to one of the two portions. In any event, several embodiments of triangle culling/clipping using a bowtie frustum are discussed below.

Before proceeding, some additional context may be helpful. Graphics engines commonly utilize multiple coordinate vector spaces. The original x,y,z coordinates defining a 3D model are commonly defined relative to a coordinate vector space for that model, referred to as model space (also known as object space). The position of each triangle vertex of a 3D model, for example, may be expressed in model space relative to a standard right-handed 3D coordinate system for that model.

A 3D scene, however, can comprise a collection of 3D models, with each 3D model having its own model space. To represent the 3D model relative to each other in a scene, the vertices of each model are transformed (moved, rotated and/or scaled) by applying a model transform (e.g., expressed as a model matrix) into a common space, referred to as world space. When models have transformed into world space, the vertices are expressed relative to the world space coordinate system.

The graphics pipeline can further apply a view transform (e.g., expressed as a view matrix) to transform vertices to a view space, also referred to as “camera space” or “eye space.” The view space simulates rendering onto a virtual camera that is arbitrarily oriented in world space. A different view transform can be applied for each hogel based on the viewpoint of the hogel. Further, a projection transform, such as an orthographic or perspective projection transform, can be applied to transform vertices into homogeneous coordinates.

According to some embodiments, a 2D array of hogels/hogel cameras is modeled using a hogel plane definition (HPD). The transform of the virtual hogels/hogel cameras represented by the HPD to world space by expressed as the dot product of a view volume transform (VVT)*HPD. A viewpoint-specific transform that expresses the relationship between a particular viewpoint and the view volume, can be applied to transform coordinates from world space to a viewpoint specific eye space.

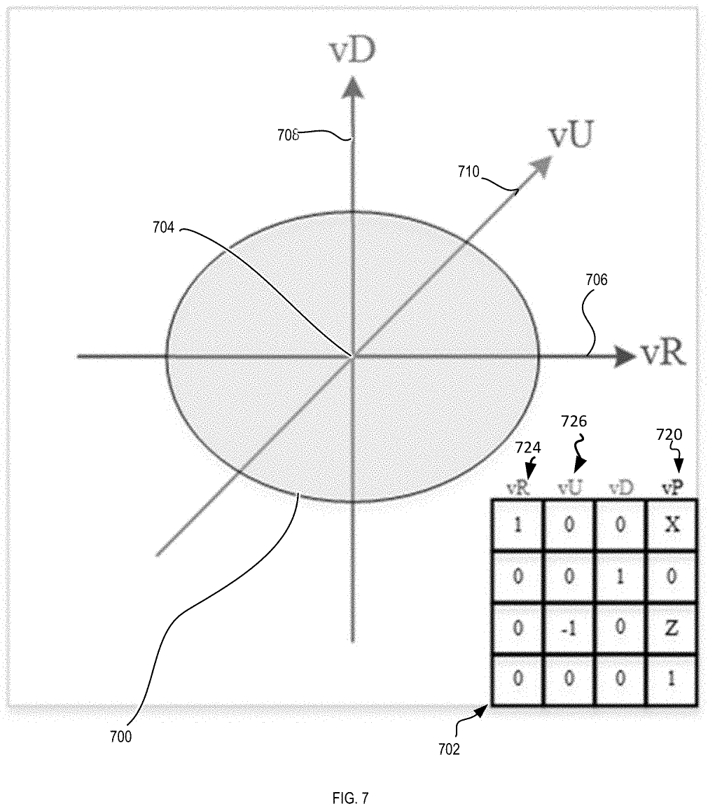

Before discussing embodiments of the HDP and the VVT further, it can be noted that, for purposes of explanation, this disclosure describes various embodiments using a standard, right-handed, ‘Y-UP’, coordinate system that is common in many OpenGL applications. For example, FIG. 6 illustrates a standard, right-handed, ‘Y-UP’, coordinate system 600. In some embodiments at least one of world space, model space, or HDP space use a Y-UP coordinate system. However, other coordinate systems may be used.

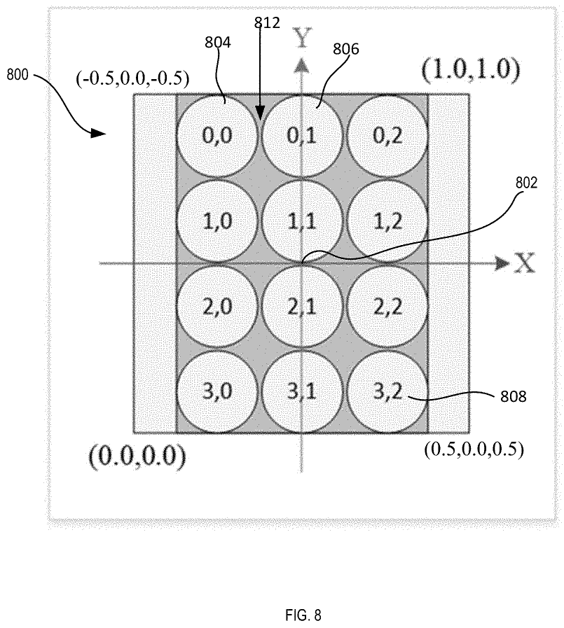

According to one embodiment, each virtual hogel can be defined in a 3D space by a camera matrix. Turning to FIG. 7, virtual hogel 700 is defined by a camera matrix 702 (in this example, a bowtie frustum projection matrix) that specifies a position vector vP that points to the camera's position 704, which maps to the optical center of a corresponding actual hogel in some embodiments. Camera matrix 702 further defines a right vector (vR) that represents the positive x-axis 706 of the camera space, a direction vector (vD) that represents the direction 708 in which the camera is pointing, and an up vector (vU) that specifies the y-axis 710 in the camera's space. In a right-handed, ‘Y-UP’, coordinate system, the hogel (virtual) bowtie camera faces up with the camera direction vector along the positive y-axis and the corresponding camera up-vector along the negative z-axis. It will be appreciated though, that other coordinate systems may be used.

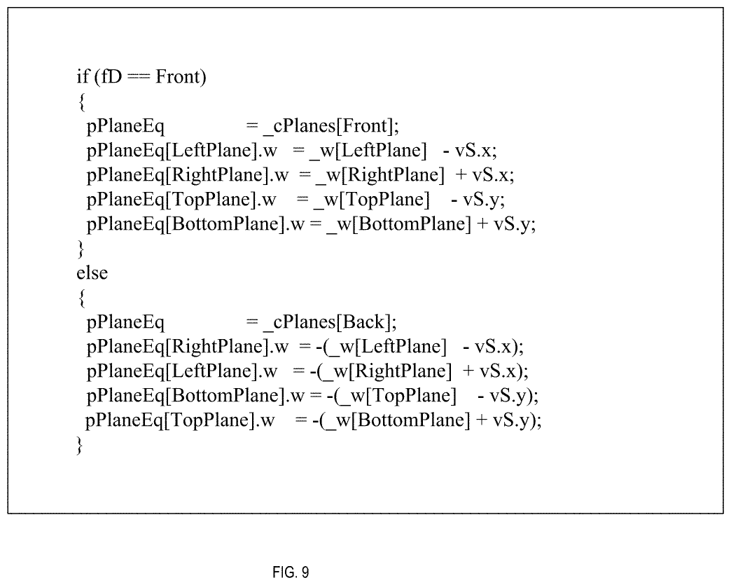

A hogel plane can be defined on the x-z plane, normalized, and centered. According to one aspect of the present disclosure, a hogel plane can be defined by a hogel plane definition (HPD) (also referred to as a radiance image definition). FIG. 8 is a diagrammatic representation of one embodiment of a hogel plane definition 800. FIG. 8 illustrates the HPD in two coordinate spaces, a 3D HPD Y-Up space and a viewport space. In HPD space, the hogel plane is located on the x-z plane and normalized between coordinates, for example, (−0.5, 0, 0.5) and (0.5, 0, 0.5). The origin 802 of the hogel plane and the center of each hogel center of each hogel (e.g., hogel 804, hogel 806, hogel 808, and so on) is located on the x-z plane. The coordinate space of the HPD is referred to as the HPD space. Further, FIG. 8 illustrates mapping the hogel plane onto the x-y plane of a 2D normalized viewport space that extends between (0.0, 0.0) (for the bottom left of the radiance image) to (1.0, 1.0) (top right of the radiance image).

According to one aspect of the present disclosure, HPD 800 comprises a 2D array of hogel camera matrices with accompanying centers in the hogel plane definition. Further, HPD defines the hogel frustum planes or includes information to derive the hogel frustum planes for each hogel in the hogel plane. As such, HPD 800 can also be considered a 2D array of hogel bowtie frustums.

In the example of FIG. 8, HPD 800 defines a hogel plane having twelve hogels. The hogels are indexed—for example numbered from left to right, top to bottom (e.g., (0,0) for the bottom left, (1,1) for the top right of the radiance image)—and assigned a center coordinate in the HDP space. Thus, the position vector of the camera matrix for hogel 0,0 points to the center coordinate of hogel 0,0 the position vector of the camera matrix for hogel 1,1 points to the center coordinate assigned to hogel 1,1, and so on.

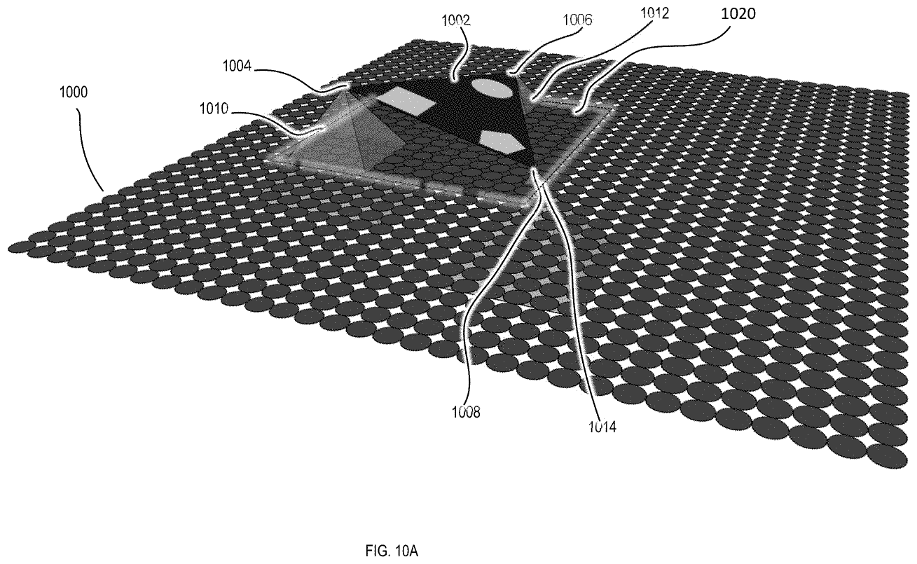

Further, HPD 800 implicitly or explicitly defines the frustum planes (e.g., bowtie frustum planes) for each hogel 0,0 through 1,1. In one embodiment, HPD 800 includes an explicit definition of the bowtie frustum for each hogel represented in the HPD. However, since all the hogels represented in HPD 800 lie in a plane and have the same orientation, HPD 800 can include the definition of set of frustum planes associated with a point on the hogel plane (for example, frustum planes having an origin at the center coordinate for hogel 1,1 (or other hogel) or frustum planes having an origin at the origin 802 of the normalized hogel plane). The frustum planes for the (other) hogels can be calculated from the one set of frustum planes as needed. One embodiment of determining frustums from a known frustum is described in conjunction with FIG. 9.

According to one embodiment, the frustum planes for a hogel can be determined using the camera matrix for the hogel. Referring back briefly to FIG. 7 and FIG. 5, for example, the bowtie frustum planes for hogel 700 can be calculated according to FIG. 5 and using camera matrix 702. It should be noted that while FIG. 5 refers to “rows,” embodiments may use the columns from hogel matrix 702 because camera matrix 702 is column major. According to the embodiment of FIG. 5, the front (i.e., to the fore of the image plane) right plane for hogel 700 is determined by subtracting column 724 from column 720, the front left plane is determined by adding column 724 to column 720, the front bottom plane is determined by adding column 726 to column 720, and the front top plane is determined by subtracting column 726 from column 720. The side planes on the back side of the bowtie frustum are the inverse of those on the front side. That is, the back left plane is the inverse of the front right plane, the back right plane is the inverse of the front left plane, the back bottom plane is the inverse of the front top plane and the back top plane is the inverse of the front bottom plane.

In some embodiments, the size of each hogel (e.g., diameter) and pitch (e.g., spacing between the hogels, such as gap 812 between hogel 804 and hogel 806 are encoded in the HPD. In embodiments in which the hogels are all the same diameter and the spacing between them consistent, the size of the hogels may be inferred.

While only twelve hogels are represented by HPD 800 in FIG. 8, other embodiments may represent any number of hogels (for example, thousands of hogels). Moreover, the coordinate system and indexing may be different according to the nature, orientation, and construction of the LfD or other display or based on other factors.

A view volume transform (VVT) expresses the relationship between a view volume about the optical center of the display and world space. According to one embodiment, a VVT is a 4×4 transform matrix that defines a 3D cuboid volume in world space to be rendered. In other words, the VVT defines the 3D cuboid volume within a scene that a volumetric, light-field, or holographic display projects. Multiplying the hogel camera matrices defined within the HPD by the VVT transforms the hogel cameras into world space.

Embodiments can use the HPD in various operations, such as, but not limited to, object and triangle culling. The culling operations are performed with the hogel plane and the object extents or triangle in the same space. For example, the object extents or triangle vertexes can be mapped to HPD space. As another non-limiting example, the HPD can be mapped to a model space to perform culling.

Some embodiments of bowtie renderers use bowtie frustums for object culling. In prior graphics pipelines, object culling is typically done by comparing an object's bounding volume for intersection with a camera frustum. However, the HPD may define a large number of virtual cameras and frustums (e.g., tens of thousands of hogel cameras/frustums). Object culling by testing the object's bounding volume against a large number of camera frustums can be a computationally expensive task. Object culling may proceed in a manner similar to triangle culling discussed below, but the frustums are reverse casting from the bounding volume extents.

According to one embodiment, object culling is performed in an HPD space using reverse casting of bowtie frustums. It is more efficient to transform an object's maximum and minimum bounding volume extents into the HPD space and then reverse cast the frustum edges from the transformed extents onto the normalized hogel image plane. The resulting intersections encompass the subset of hogel frustums that intersect the object's bounding volume. Limiting the processing of objects within that narrower subset of hogels can speed up rendering significantly.

According to another embodiment, the HPD can be transformed into an object's model space, preserving the relative position and orientation of the model. A transformed radiance image bowtie frustum can then be transformed to the object's bounding volume minimum and maximum extents. The resulting plane equations define a series of edges. The outermost edges can be checked for intersection with the hogels of the transformed radiance image hogel plane. The resulting intersections encompass the subset of hogel frustums that intersect the object's bounding volume. Limiting the processing of objects to within that narrower subset of hogels can speed up rendering.

In any case, the minimum and maximum indices calculated by the reverse frustum cast can be used to define the indexable extent within the hogel plane definition (a 2D subset of hogels) for further processing the object's geometry.

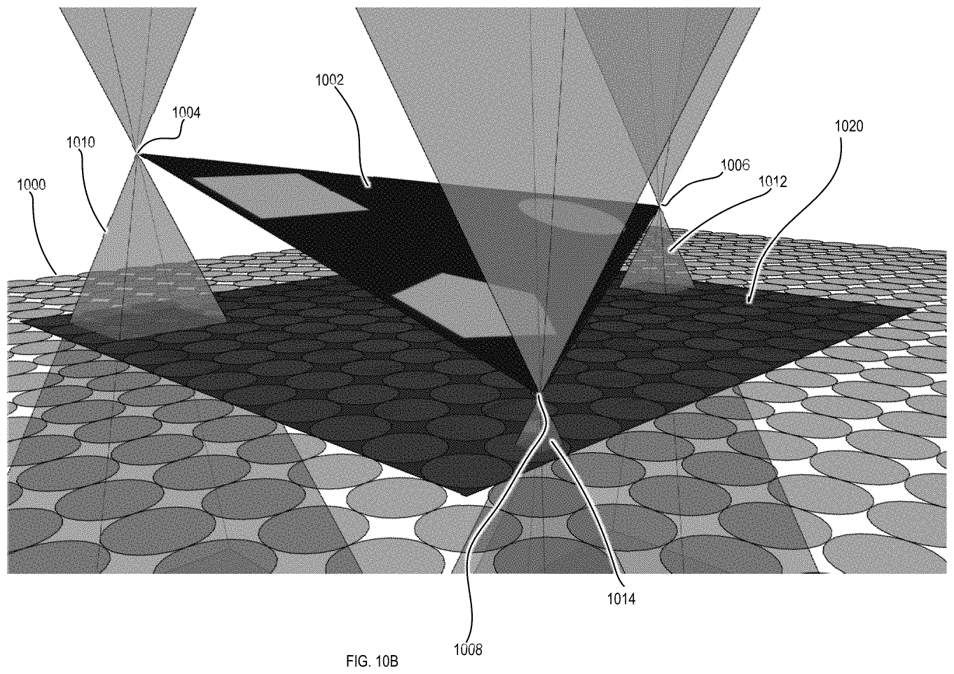

According to one aspect of the present disclosure, some bowtie renderers can perform culling into the HPD space. Turning briefly to FIG. 10A and FIG. 10B, FIG. 10A illustrates one embodiment of a reverse frustum cast from a triangle's vertices. FIG. 10B provides a closer view of FIG. 10A from a second perspective. In FIG. 10A and FIG. 10B the vertices of a triangle 1002 are transformed into HPD space (for example, vertex 1004, vertex 1006, and vertex 1008 of triangle 1002 are transformed to the HPD space) and the frustum edges cast from the vertices onto the hogel plane, isolating the subset of hogels having frustums that intersect that triangle. In another embodiment, the hogel plane is transformed into the model space of an object (e.g., hogel plane 1000 is transformed to the model space in which triangle 1002 is defined) and frustum are reverse cast from the vertices onto the hogel plane, transformed into model space.

In a culling operation, a bowtie frustum is projected from each vertex at least toward the hogel plane 1000. For example, bowtie frustum 1010 is projected from vertex 1004 (the side planes of bowtie frustum 1010 each pass-through vertex 1004), bowtie frustum 1012 is projected from vertex 1006 (the side planes of bowtie frustum 1012 each pass-through vertex 1004), bowtie frustum 1014 is projected from vertex 1008 (the side planes of bowtie frustum 1014 each pass-through vertex 1008). Bowtie frustum 1010, bowtie frustum 1012, and bowtie frustum 1014 can each have the same frustum definition as the bowtie frustums defined for the virtual hogels of hogel plane 1000 but shifted to the vertices of triangle 1002 in the HPD space. In one embodiment, for example, the frustum for a vertex is determined according to FIG. 5, using the columns of a camera matrix, such as camera matrix 702, in which the information in position column 720 corresponds to the vertex.

Each hogel can be considered a circle/cell on the hogel plane. The intersections of the frustum planes with the hogels can be calculated using any suitable intersection testing algorithm known or developed in the art. The intersections of the frustum with the hogel plane are converted to the indices of the hogels intersected by the frustum. The resulting intersections encompass the subset of hogel frustums that intersect triangle 1002. In this example, only the frustums of the virtual hogels in area 1020 will intersect triangle 1002. The portion of a hogel plane identified by reverse frustum projection can be referred to as a “reverse frustum projection hogel plane.”

As may be recalled, each hogel in the hogel plane can have an assigned index (x, z) (e.g., (0,0) through (n, n) for a square hogel plane. The minimum and maximum hogel indices determined by the reverse frustum cast can be used to define the indexable extent within the hogel plane definition to use during clipping. Using the index values of the hogels intersected by the reverse cast frustums, the reverse frustum projection plane can be defined as the rectangle of hogels having corners at (xₘᵢₙ, zₘᵢₙ), xₘₐₓ, zₘᵢₙ), xₘᵢₙ, zₘₐₓ), xₘₐₓ, zₘₐₓ), where xₘᵢₙ, zₘᵢₙ, xₘₐₓ, zₘₐₓ are the max and min x and z indices of the hogels intersected by the reverse cast frustums. However, as illustrated in FIGS. 10A and 10B, the corner hogels, in some cases, are not necessarily intersected by the frustum. In the examples of FIGS. 10A and 10B, for example, area 1020 can represent the indexable extent within the hogel plane to use when performing clipping tests on triangle 1002. Thus, for example, clipping operations may only have to index through the indices within the indexable extent identified through reverse frustum casting.

While FIG. 10A and FIG. 10B illustrate reverse casting frustums for a single triangle, it will be appreciated how a similar process can be used for object culling. For a multiple triangle object, the extents of the object are mapped to the HDP space, and frustums reverse cast from those points to determine the subset of hogels that have frustums that intersect the object. Limiting the processing of the object to within that narrower subset of hogels which have frustums that intersect the object can significantly speed up rendering.

Moreover, it can be noted that object culling may be used to determine a first reverse frustum projection hogel plane applicable to processing an object. Triangle culling may determine a second reverse frustum projection hogel plane applicable to processing a particular triangle of the object, where the second reverse frustum projection hogel plane is a subset of the first reverse frustum projection hogel plane. Using FIG. 10A and FIG. 10B as an example, hogel plane 1000 may be a complete hogel plane or may represent a reverse frustum projection hogel plane previously determined through object culling. In the later example, area 1020 would thus represent a further reduction in the number of hogels that have to be considered, specific to further processing of triangle 1002.

3D graphics pipelines typically expect a triangle's vertices to be multiplied by the model-view-projection (MVP) matrix before being submitted to the rasterizer for clipping/culling in unity clip space. However, this implies at least three [4×4] matrix by [4×1] vertex multiples (˜48 multiplies) per triangle per hogel tested, which can be a significant number of multiplications (and additions) to determine if a triangle is visible to an individual hogel frustum. Moreover, hogel frustum definitions can be narrow, resulting in many culled or clipped triangles. Therefore, a bowtie renderer, according to one embodiment, clips in model space to avoid many unnecessary triangle vertex transforms.

As described in “Fast Extraction of Viewing Frustum Planes from the World-View Projection Matrix,” (Gil Gribb, Klaus Hartmann 2001), which is hereby fully incorporated by reference herein, there are techniques for deriving clipping planes from an MVP matrix to allows for clipping in model space. This implies, though, that on a per-object basis, the intersecting HPD subregion of hogels that have frustums that intersect the object would need to be transformed into the object's model space to determine the necessary clipping planes.

In some embodiments, all the hogels are on a plane and have the same orientation. As such, the frustum planes for only one hogel are transformed into the object's model space and. The remaining hogel frustum planes can be calculated merely by shifting one set of transformed hogel frustum planes with a few scaled additions to shift the transformed hogel frustum planes with a few scaled additions. Therefore, as part of the HPD, one set of hogel frustum planes can be defined at the origin and transformed into model space when a new object enters the pipeline. Subsequent hogel-specific frustum planes are then derived through inexpensive addition operations and cached when a hogel frustum requires an intersection test with the first triangle of an object. In this manner, hogel frustum planes are efficiently calculated once per object render and only when necessary. Further, if object culling or triangle culling was performed, then the hogel frustum planes only need to be determined (as needed) for the hogels in the subregion of (e.g., the reverse frustum projection hogel plane determined from object culling and/or triangle culling).

FIG. 9 provides one example embodiment of code for shifting the clipping planes for other hogels in a hogel plane through a scaled addition. In FIG. 9, the left, right, top, and bottom planes refer to the side planes of the bowtie frustum. Given the frustum plane definition of a hogel at the origin (0,0), the other hogel frustums can be determined according to FIG. 9, where vS·x is lateral step along the X-axis and vS·y is the lateral step along the Z-axis in the HPD space.

Therefore, as part of the HPD, one set of hogel frustum planes can be defined at the HPD origin and transformed into model space (for example, when a new object enters the pipeline). Subsequent hogel-specific frustum planes are then derived through inexpensive addition operations. The hogel-specific frustum planes can be cached when an intersection test is required to test a hogel-specific frustum with the first triangle of an object. In this manner, hogel frustum planes can be efficiently calculated once per object render and only when necessary. If the triangle intersects a frustum plane, the triangle can be clipped to the plane in model space. Any suitable clipping algorithm known or developed in the art can be applied to clip polygons (e.g., triangles) to the hogel-specific frustum planes, including, but not limited to the Sutherland-Hodgman algorithm and variations thereof (the basis for the Sutherland-Hodgman algorithm was initially described in Ivan Sutherland, Gary W. Hodgman: “Reentrant Polygon Clipping,” Communications of the ACM, vol. 17, pp. 32-42, 1974, which is hereby fully incorporated herein by reference herein).

Reverse frustum casting can be used to identify a subset of hogels for further processing of an object or polygon, such as identifying a subset of hogels for clipping/intersection testing. In addition, or in the alternative, some embodiments utilize smart clipping algorithms in which the result of an intersection test returns direction information that can be used to select the hogel to test. Clipping algorithms such as Sutherland-Hodgman algorithm use a distance point to plane dot product calculation to determine whether a point is behind, on or in front of a plane. Therefore, during a Sutherland-Hodgman edge clip operation the cardinal direction of where points of a triangle lie relative to the frustum can be recorded and used to prevent or reduce future hogel frustum intersection tests.

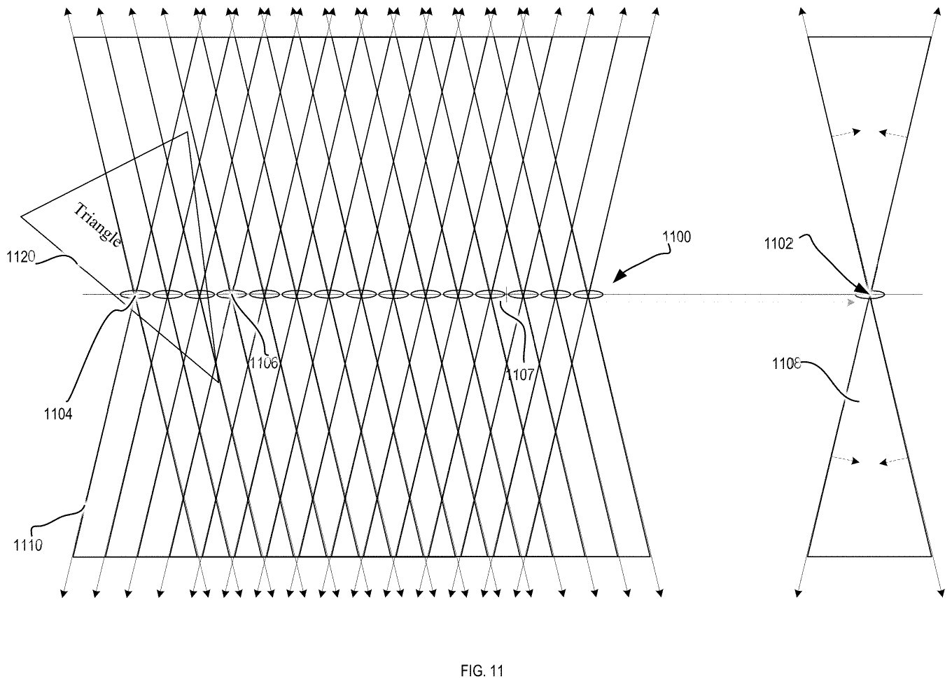

Turning to FIG. 11, illustrates one embodiment of testing a triangle for hogel frustum intersection. In the illustrated embodiment, a hogel plane 1100 comprises a plurality of virtual hogels (e.g., hogel 1102, hogel 1104, hogel 1106 and hogel 1107 are labeled, and some hogels are omitted for clarity). Each hogel has a hogel bowtie frustum (e.g., frustum 1108 of hogel 1102 and frustum 1110 of hogel 1104 are labeled). FIG. 11 further illustrates an example of testing a triangle 1120. If the center-most hogel, say hogel 1107, was tested against triangle 1120, the result would be a fully culled triangle and a flag/bit mask indicating that all the triangle vertices were to the left (or west). Therefore, no hogel frustum in the same up/down (North/South) column or any frustum to the right (east) would require testing.

The clip direction knowledge can be used to quickly terminate indexing, for example:

for(idx·x=v Min·x;(idx·x<=vMax·x)&&(!AllPointsLeft);idx·x++)

Indexing can similarly be terminated for the z index.

In this example, after testing a hogel and determining that the hogel frustum does not intersect the triangle, the range of x index values is reduced so that only hogels to the left of the tested hogel (hogel 1107) will be tested against triangle 1120.

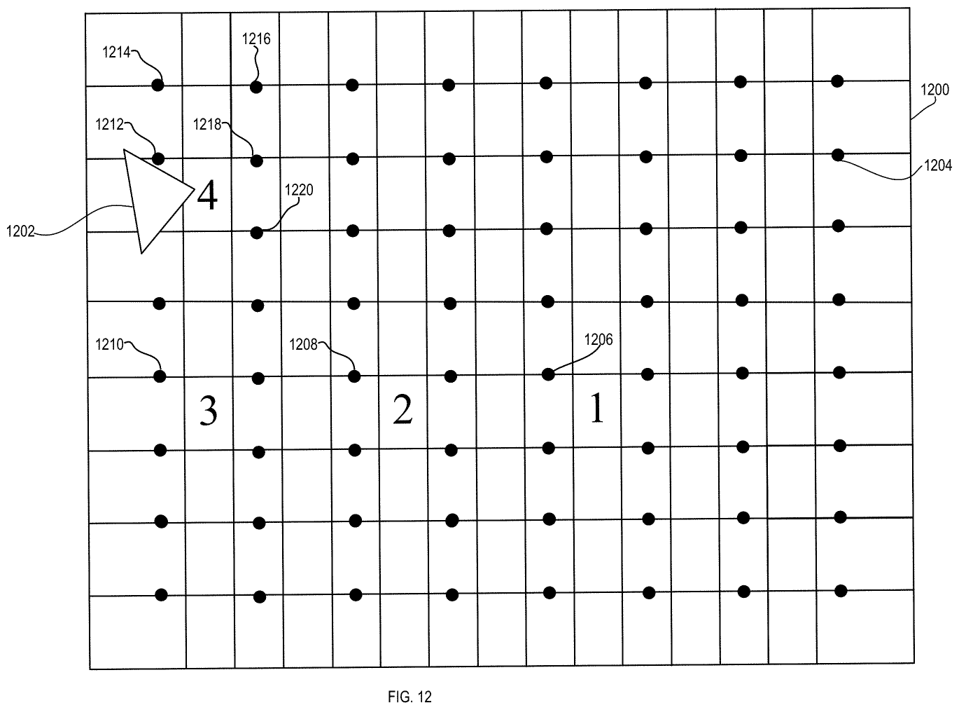

Therefore, in another embodiment, instead of indexing through the HPD using indices calculated by the reverse frustum cast, the clip direction can be used to binary search through the HPD to find a valid triangle intersection. FIG. 12 illustrates one embodiment of performing a binary search for hogel frustum intersection. In FIG. 12, a hogel plane 1200 and triangle 1202 are illustrated. In the representation of FIG. 12 each black dot represents the origin of a respective hogel (e.g., hogel 1204) in the hogel plane and the squares around the dots represent the respective and overlapping hogel frustums. In this example, triangle 1202 is on the left side of hogel plane 1200 (looking down onto the hogel plane). Further, hogel plane 1200 may be a reverse frustum projection hogel plane identified by reverse frustum projection (e.g., as determined, for example, according to FIG. 10A and FIG. 10B).

During a binary search, the centermost hogel of a hogel plane may be selected first. If the frustum of the hogel does not intersect the triangle, the clipping/culling operation can return the direction to search. A bowtie frustum comprises four side planes and each plane has a normal which is perpendicular to the plane. When a plane is tested for intersection, and all vertices are outside the plane, then the normal indicates the general direction of the vertices relative to that plane. This information can be used to select a direction when indexing through the hogels in the hogel plane.

For example, frustum of the center hogel 1206 is tested first to determine if it intersects with triangle 1202. Since the frustum of hogel 1206 does not intersect triangle 1202 and all the vertices of triangle 1202 are to the north and left of hogel 1206, the clipping algorithm can select a direction to select a hogel that is closer to the triangle, for example to move/search left. The frustum of a second hogel 1208 is tested, where the second hogel 1208 is half-way between the left edge of the hogel plane 1200 and the first hogel 1206. Since the frustum of hogel 1208 does not intersect triangle 1202 and all the vertices of triangle 1202 are to the north and left of hogel 1206, the clipping algorithm can continue to move to the left.

The frustum of a third hogel 1210 that is to the left of second hogel 1208 is tested. Since the frustum of hogel 1210 does not intersect triangle 1202 and all the vertices of triangle 1202 are to the north of hogel 1210, the clipping algorithm moves north and tests hogel 1212. The frustum of hogel 1212 does intersect triangle 1202. Once an intersection is found (any triangle edge crossing any hogel frustum plane) the search can stop, after which, neighboring hogels (e.g., hogel 1214, hogel 1216, hogel 1218, hogel 1220, the hogel obscured by triangle 1202) are scheduled for intersection testing. If the frustum planes of any of those hogels intersect triangle 1202, the neighboring hogels of that hogel are scheduled for intersection testing, and so on.

If the plane equations are normalized, then the clip/cull directions can be accompanied by distances, which can be used to further restrict the search space. As such, if a triangle is fully culled by a frustum clip operation, the clipper returns a vector (distance/direction) from the frustum center to the center of the triangle in model space. The next frustum for clipping can then be calculated directly from the hogel plane definition.

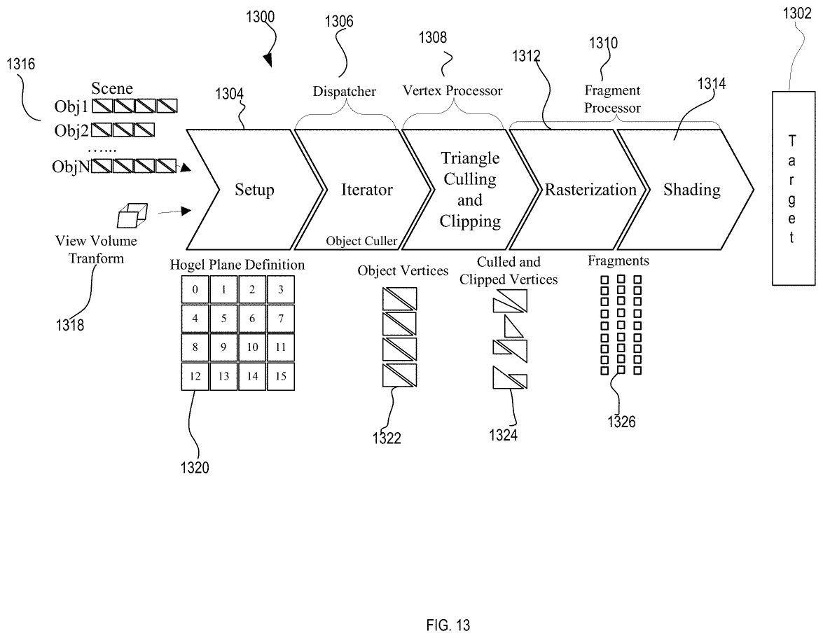

FIG. 13 is a diagrammatic representation of one embodiment of a radiance image rendering pipeline 1300 for rendering a micro-image to a target 1302. By way of example, but not limitation, target 1302 may be a viewport in a frame buffer or a location in a tagged list that is used by downstream software/hardware to project an image. Pipeline 1300 includes a setup stage 1304, a dispatcher 1306, a vertex processor 1308, and a fragment processor 1310. Fragment processor 1310 includes a rasterizer 1312 and a shader 1314. In the embodiment of FIG. 13 a single pipeline is illustrated. In some embodiments there may be multiple parallel pipelines. In any case, pipeline 1300 may be responsible for multiple hogels. In such an embodiment, pipeline 1300 may iterate through multiple viewpoints/viewports for which it is responsible to render to all applicable hogels. The extent of render target indexing when processing a triangle from an object may be limited to those targets that correspond to a reverse frustum projection hogel plane as determined by object culling or triangle culling.

According to one embodiment, pipeline 1300 indexes through geometry of the scene and the render targets for which it is responsible giving triangle major priority. In other words, pipeline 1300 will process a triangle and index through the render targets to render the triangle to all the render targets for which pipeline is responsible as appropriate. Then the next triangle can be rendered to the render targets as appropriate. For example, if pipeline 1300 is responsible for rendering to sixteen targets 1302 (e.g., sixteen viewports or sixteen hogels), pipeline 1300 will render a triangle from a scene to the sixteen targets 1302 as appropriate before rendering the next triangle in the scene. This is different from a traditional GPU pipeline, which will render all the geometry for one view/hogel before moving to the next view/hogel.

In operation, pipeline 1300 receives scene data 1316 from a host application or other source. Scene data 1316 may include, for example, data for one or more 3D models, such as, for example, geometry (e.g., vertex lists), texture, lighting, shading, bounding volumes (e.g., sphere or cuboid) and other information as a description of the virtual scene. Pipeline 1300 further receives or accesses a view volume transform (VVT) 1318 that expresses the relationship between a view volume that represents a volume about the optical center of the display and world space. According to one embodiment, VVT 1318 is a 4×4 transform matrix that defines a 3D cuboid volume in world space to be rendered. In other words, the VVT, according to one embodiment, defines the 3D cuboid volume within a scene that a volumetric, light-field, or holographic display projects.

Pipeline 1300 further receives or accesses a hogel definition plane (HPD) 1320, which according to one embodiment, is a 2D array of hogel camera matrices and accompanying viewport centers in a radiance image rendering view definition. HPD 1320 may further define or include information usable by pipeline 1300 to determine the hogel frustums. In some embodiments pipeline 1300 is configured with HPD 1320 by, for example, the manufacturer of a display.

Setup stage 1304 performs a variety of operations to prepare for a render cycle that, for example, clears buffers and performs other setup operations to prepare for a render cycle. The setup operations can include various operations dependent on the multi-view computing system implementation.

Dispatcher 1306 is responsible for iterating the scene objects and vertex lists and dispatching triangles to a vertex processor 1308. According to one embodiment, dispatcher 1306 performs object culling if object culling is enabled. Various types of object culling may be implemented including, but not limited to, object culling using reverse casting of frustums from the object's maximum and minimum bounding volume extents onto the hogel plane, which can be performed in HPD space or model space in some embodiments. Dispatcher 1306 dispatches the object vertices 1322 to vertex processor 1308.

If object culling is enabled, dispatcher 1306 determines the hogels of interest for processing of the object and dispatches this information with the triangles of the object to the culling and clipping stage. For example, dispatcher 1306 can provide the indexable extent within the hogel plane definition to use during downstream operations for processing of the geometry of the object. According to one aspect of the present disclosure, dispatcher 1306 provides an indication of a reverse frustum projection hogel plane determined for the object.

Vertex processor 1308 performs triangle culling and triangle clipping. Triangle culling and clipping is a processing stage where triangles are transformed, clipped and/or culled in an algorithm specific manner and order. According to one embodiment, the culling and clipping stage determines for each triangle, the subset of hogels that have hogel frustums that intersect the triangle and then performs clipping based on those hogels. The triangle culling and clipping stage can pass clipped vertices 1324 to a fragment processor to perform rasterization and shading according to rasterization and shading techniques known or developed in the art.

In various embodiments, triangle culling for a triangle of an object is performed in the HPD space. In addition, or in the alternative, triangle culling is performed in model space. Vertex processor 1308 may implement various triangle culling techniques known or developed in the art, including, but not limited to, triangle culling techniques discussed in conjunction with FIG. 10A and FIG. 10B. Further, in one embodiment, vertex processor 1308 performs triangle clipping in model space. Various intersection testing techniques and clipping techniques known or developed in the art can be used to determine whether a triangle intersects a hogel frustum plane and to clip triangles to hogel frustum claims, including, but not limited to those discussed above in conjunction with FIG. 11 and FIG. 12. In some embodiments, clipping a triangle to a frustum can occur as described in U.S. Pat. No. 10,573,056, but in model space. Further, viewer facing (typically referred to as backface culling) tests can be performed and polygons not facing the viewer culled. It will be appreciated that for a LfD, backface culling is performed based on the viewer being outside of the view volume, looking onto the hogel plane or, in other words, with the viewer into looking into the front facing bowtie frustums.

Vertex processor 1308 provides culled and clipped vertices 1324 to fragment processor 1310. However, prior to forwarding the culled and clipped vertices for a triangle to fragment processor 1310, vertex processor 1308 may perform other transformations, such as applying M,V,P transforms to the remaining triangles/polygon vertices. Vertex processor 1308 clips a triangle for each hogel having a hogel camera frustum that intersects the triangle (at least for the hogels for which pipeline 1300 is responsible for rendering). If vertex processor 1308 performs processing for multiple hogels/viewpoints, then vertex processor 1308 generates a unique set of triangle intersection vertices for each intersected hogel which are passed to the fragment processor. Clipping in model space can reduce the computational burden on the multi-view vertex processor.

Rasterization is the process of converting a polygonal model into a raster or pixel image; for example, rasterization renders a hogel image data (or other multi-view image) from a triangle list. Rasterization occurs after the vertex transform stage of the render pipeline and generates a list of fragments 1326. Rasterizer 1312 may perform rasterization according to any suitable rasterization technique known or developed in the art including, but not limited to, those described in U.S. Pat. No. 10,573,056.

The fragments 1326 are shaded by shader 1314 based on the textures/materials/etc. associated with the scene. For example, the texture mapped on the surface of each polygon can be based on a linear interpolation of the texture coordinates. Shading can be performed according to various techniques, including but not limited to, the Phong Reflection Model, described in Phong, Bui Tuong “Illumination for Computer Generated Graphics,” Communications of the ACM, Vol. 18, No. 6, Association of Computing Machinery, Inc. (June 1975). The Phong algorithm is a simple shading model that describes the manner in which light reflects off a surface. The Phong model uses an ambient, diffuse and specular description of both the surface material and source light to accumulate a pixel color value for a fragment. The specular component requires knowledge of the light position (in camera space) and the surface normal for each fragment. It can be noted that if a normalized eye space x (n-eye) is used, the lighting angle can also be adjusted to account for changes in angles due to the transform to the normalized eye space.

Pipeline 1300 may perform other operations such as correction of the rendered images to account for any micro-lens distortions or color aberrations. Vertex processor 1308 performs operations on triangles, such as applying transformations, triangle clipping and culling.

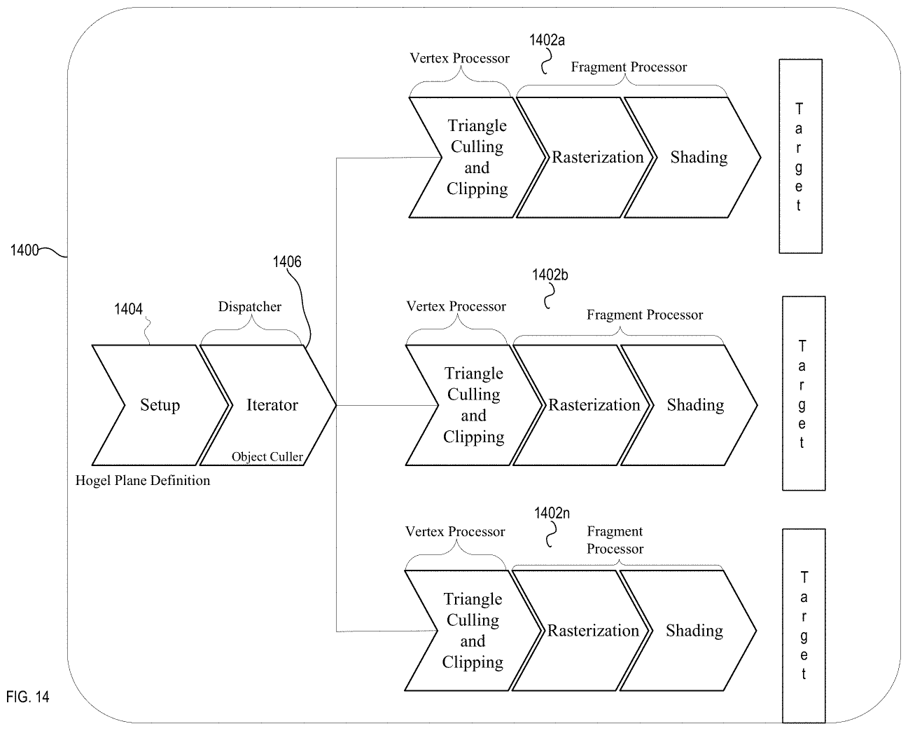

FIG. 14 is a diagrammatic representation of one embodiment of an MvPU 1400. In the embodiment illustrated, MvPU 1400 implements multiple parallel pipelines 1402a, 1402b-1402n, with each pipeline rendering for a subset of hogels. There may be fewer pipelines than hogels for which MvPU is responsible and the MvPU can iterate through viewpoints/viewports to schedule and/or render all applicable views (hogel images) for the hogels for which the MvPU is responsible. In this embodiment, a setup stage 1404 and a dispatcher 1406. In this case, setup stage 1304 performs a variety of operations to prepare for a render cycle that, for example, clears buffers and performs other setup operations to prepare for a render cycle. The setup operations can include various operations dependent on the multi-view computing system implementation. Dispatcher 1406 is responsible for iterating the scene objects and vertex lists. Dispatcher 1406 dispatches the object vertices to the vertex processors of the parallel pipelines. If object culling is enabled, dispatcher 1406 may, for example, dispatch objects to only those pipelines that correspond to the hogels in the reverse frustum projection hogel plane. The vertex processor and fragment processor of each pipeline operates generally as discussed above with respect to FIG. 13, but may be responsible for processing only for a limited number of hogels.

MvPU 1400, according to one embodiment, can comprise a highly parallel array processor configured for parallel computation of tasks and data where many threads can be executing logic against a series of queued tasks. In one embodiment, triangles are dispatched to separate render pipelines 1402a-1402n that all execute the same series of instructions to render their particular views. Therefore, hogel views can be assigned into work groups that are distributed among, for example, accelerator cores and executed concurrently.

Each pipeline 1402a-1402n can have a queue (workgroup) of viewpoints/viewports to render and a frame may be considered rendered when all the queues are empty. MvPU 1400 synchronizes between pipelines, for example, by managing triangle vertex dispatch and texture accesses within the MvPU. Dispatch of triangles within an MvPU 1400 can be synchronized so all the render pipelines are working on the same triangle or texture in parallel, but from their unique viewpoints. According to one embodiment, MvPU 1400 may implement triangle-major processing in which a triangle is rendered in parallel.

Furthermore, various techniques described herein may be applied in a variety of system architectures. Embodiments described herein may be implemented as software instructions embodied on a non-transitory computer readable medium. Embodiments may be implemented in a GPU, in an MvPU, in a processor or according to another architecture.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

At least portions of the functionalities or processes described herein can be implemented in suitable computer-executable instructions. The computer-executable instructions may reside on a computer readable medium, hardware circuitry or the like, or any combination thereof. The computer-executable instructions may be stored as software code components or modules on one or more computer readable media.

Within this disclosure, the term “computer readable medium” is not limited to ROM, RAM, and HD and can include any type of data storage medium that can be read by a processor (such as non-volatile memories, volatile memories, DASD arrays, magnetic tapes, floppy diskettes, hard drives, optical storage devices, etc. or any other appropriate computer-readable medium).

In one embodiment, the computer-executable instructions may include lines of compiled code according to a selected programming language. Any suitable programming language can be used to implement the routines, methods or programs of embodiments of the invention described herein. Different programming techniques can be employed such as procedural or object oriented.

Particular routines can execute on a single processor or multiple processors. For example, various functions of the disclosed embodiments may be distributed. Communications between systems implementing embodiments can be accomplished using any electronic, optical, radio frequency signals, or other suitable methods and tools of communication in compliance with various protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

Although the present invention has been described in detail, it should be understood that various changes, substitutions and alterations can be made hereto without departing from the spirit and scope of the invention.

What is claimed is:

1. A method for processing three-dimensional (3D) graphics data, the method comprising:
receiving 3D geometry data for a shape to be rendered to a display that comprises an array of hogels, the shape defined in a model space; and
reducing downstream processing of the 3D geometry data to render the shape to the display, comprising identifying a subset of hogels in a hogel plane that have hogel bowtie frustums that intersect the shape.

2. The method of claim 1, wherein identifying the subset of hogels that have hogel bowtie frustums that intersect the shape further comprises reverse casting a bowtie frustum from the shape onto the hogel plane.

3. The method of claim 2, wherein the shape is an object having a bounding volume with an extent, and wherein reverse casting the bowtie frustum from the shape onto the hogel plane comprises reverse casting the bowtie frustum from the extent of the bounding volume.

4. The method of claim 3, further comprising transforming the extent from the model space to a hogel plane definition space, wherein the bowtie frustum is reverse cast in the hogel plane definition space.

5. The method of claim 2, wherein the shape comprises a triangle, the triangle comprising a vertex, and wherein reverse casting the bowtie frustum from the shape onto the hogel plane comprises reverse casting the bowtie frustum from the vertex of the triangle.

6. The method of claim 5, transforming the vertex from the model space to a hogel plane definition space, wherein reverse casting is performed in the hogel plane definition space.

7. The method of claim 5, further comprising transforming the hogel plane to the model space and performing a triangle clipping operation in the model space.

8. The method of claim 7, further comprising transforming a first hogel bowtie frustum for one of the subset of hogels to the model space, and determining hogel bowtie frustums for the others in the subset of hogels in the model space through a scaled addition.

9. The method of claim 7, wherein the triangle clipping operation returns a direction in which the triangle lies from a hogel frustum.

10. The method of claim 9, further comprising using the direction to search a 2D array of hogel frustums for an intersection with the triangle using the direction.

11. A computer program product comprising a non-transitory, computer-readable medium storing a set of computer-executable instructions, the set of computer-executable instructions comprising instructions for:
receiving 3D geometry data for a shape to be rendered to a display that comprises an array of hogels, the shape defined in a model space; and
reducing downstream processing of the 3D geometry data to render the shape to the display, comprising identifying a subset of hogels in a hogel plane that have hogel bowtie frustums that intersect the shape.

12. The computer program product of claim 11, wherein identifying the subset of hogels that have hogel bowtie frustums that intersect the shape further comprises reverse casting a bowtie frustum from the shape onto the hogel plane.

13. The computer program product of claim 12, wherein the shape is an object having a bounding volume with an extent, and wherein reverse casting the bowtie frustum from the shape onto the hogel plane comprises reverse casting the bowtie frustum from the extent of the bounding volume.

14. The computer program product of claim 13, further comprising transforming the extent from the model space to a hogel plane definition space, wherein the bowtie frustum is reverse cast in the hogel plane definition space.

15. The computer program product of claim 13, wherein the shape comprises a triangle, the triangle comprising a vertex, and wherein reverse casting the bowtie frustum from the shape onto the hogel plane comprises reverse casting the bowtie frustum from the vertex of the triangle.

16. The computer program product of claim 15, transforming the vertex from the model space to a hogel plane definition space, wherein reverse casting is performed in the hogel plane definition space.

17. The computer program product of claim 15, further comprising instructions for transforming the hogel plane to the model space and performing a triangle clipping operation in the model space.

18. The computer program product of claim 17, further comprising transforming a first hogel bowtie frustum for one of the subset of hogels to the model space, and determining hogel bowtie frustums for the others in the subset of hogels in the model space through a scaled addition.

19. The computer program product of claim 17, wherein the triangle clipping operation returns a direction in which the triangle lies from a hogel frustum.

20. The computer program product of claim 17, further comprising using the direction to search a 2D array of hogel frustums for an intersection with the triangle using the direction.

21. The computer program product of claim 11, wherein the shape is an object having a bounding volume with an extent, and wherein reverse casting the bowtie frustum from the shape onto the hogel plane comprises reverse casting the bowtie frustum from the extent of the bounding volume.

22. A graphics processing system comprising:
a memory storing a hogel plane definition defining a hogel plane;
a processor configured to:
receive 3D geometry data for a shape to be rendered to a display that comprises an array of hogels, the shape defined in a model space; and
reduce downstream processing of the 3D geometry data to render the shape to the display, comprising identifying a subset of hogels in a hogel plane that have hogel bowtie frustums that intersect the shape.

23. The graphics processing system of claim 22, wherein the processor is further configured to perform triangle clipping in model space using a hogel camera bowtie frustum.
